(19) United States
(12) Patent Application Publication
(10) Pub. No.: US 2023/0076481 A1
(43) Pub. Date: Mar. 9, 2023

(54) MEMORY THERMAL THROTTLING METHOD AND MEMORY THERMAL THROTTLING SYSTEM

(71) Applicant: Hefei Core Storage Electronic Limited, Anhui (CN)

(72) Inventors: Ren Jun Tang, Anhui (CN); Weikang Wang, Anhui (CN); Hai Han, Liaoning (CN); Jun Liang, Anhui (CN); Biao Zhang, Anhui (CN)

(73) Assignee: Hefei Core Storage Electronic Limited, Anhui (CN)

(21) Appl. No.: 17/485,510

(22) Filed: Sep. 27, 2021

(30) Foreign Application Priority Data
Sep. 1, 2021 (CN) 202111018799.3

(51) Int. Cl. G06F 3/06; G01K 3/14; G01K 3/00

(52) U.S. Cl. CPC G06F 3/0632; G06F 3/0604; G06F 3/0659; G06F 3/0673; G06F 3/0653; G01K 3/14; G01K 3/005

(57) ABSTRACT

A memory thermal throttling method and a memory thermal throttling system are provided. The method includes: performing, by a testing equipment, test modes on a memory storage device, and obtaining an internal temperature of a memory control circuit unit, a work loading of each memory package and a surface temperature of each memory package to establish a linear relationship between the work loading, the internal temperature, and the surface temperature; storing, by the testing equipment, the linear relationship in the memory storage device; using, by the memory storage device, the linear relationship based on a current internal temperature of the memory control circuit unit and a current work loading of a first memory package of the memory packages to calculate a predicted surface temperature of the first memory package; adjusting, by the memory storage device, an operating frequency for accessing the first memory package based on the predicted surface temperature.

### CROSS-REFERENCE TO RELATED APPLICATION

This application claims the priority benefit of China application serial no. 202111018799.3, filed on Sep. 1, 2021. The entirety of the above-mentioned patent application is hereby incorporated by reference herein and made a part of this specification.

### BACKGROUND

### 1. Technical Field

The disclosure relates to a memory temperature control technology, and particularly relates to a memory thermal throttling method and a memory thermal throttling system.

### 2. Description of Related Art

Digital cameras, mobile phones and MP3 have grown rapidly in the past few years, which has led to a rapid increase in consumer demand for storage media. Because rewritable non-volatile memory has the characteristics of non-volatile data, power saving, small size, no mechanical structure, and fast reading and writing speed, it is most suitable for portable electronic products, such as notebook computers. A solid state drive is a memory storage device that uses a flash memory module as a storage medium. Therefore, the flash memory industry has become a very popular part of the electronics industry in recent years.

Generally speaking, a large amount of heat energy is generated when a memory storage device operates. With the trend of rewritable non-volatile memory modules with larger capacity and faster speeds in small-size products, the risk of memory storage devices overheating is increasing. In order to prevent the memory storage device from being damaged by overheating, the temperature of the memory storage device must be kept below a certain temperature. In the prior art, generally, a thermal sensor provided in the memory storage device is configured to measure the surface temperature of the memory package closest to the memory controller, and the measured temperature is configured to determine whether a speed reduction is required. However, the memory controller does not only access the memory package closest to the memory controller, and the temperature of a single memory package device cannot represent the temperature of all memory packages. It is not accurate to use only the temperature of a single memory package to determine whether a speed reduction is required. Therefore, how to design a memory storage device that takes into account the thermal throttling efficiency and saves the circuit layout space of a PCB substrate is a topic of concern to those skilled in the art.

### SUMMARY

The disclosure provides a memory thermal throttling method and a memory thermal throttling system capable of improving the thermal throttling efficiency and save the circuit layout space of a PCB substrate.

The embodiment of the disclosure provides a memory thermal throttling method used in a memory storage device. The memory storage device includes a memory control circuit unit and multiple memory packages. The method includes: performing, by a testing equipment, multiple test modes on the memory storage device, and obtaining an internal temperature of the memory control circuit unit, a work loading of each of the memory packages, and a surface temperature of each of the memory packages so as to establish a linear relationship between the work loading, the internal temperature, and the surface temperature; storing, by the testing equipment, the linear relationship in the memory storage device; using, by the memory storage device, the linear relationship based on a current internal temperature of the memory control circuit unit and a current work loading of a first memory package of the multiple memory packages to calculate a predicted surface temperature of the first memory package; and adjusting, by the memory storage device, an operating frequency for accessing the first memory package based on the predicted surface temperature.

In an embodiment of the disclosure, when the multiple test modes are performed, the testing equipment transmits at least one command to the memory storage device, and the memory storage device receives and performs the at least one command.

In an embodiment of the disclosure, the at least one command includes at least one of a write command and a read command.

In an embodiment of the disclosure, the work loading includes amount of data written to the memory package.

In an embodiment of the disclosure, a step of adjusting the operating frequency for accessing the first memory package by the memory storage device based on the predicted surface temperature includes: determining whether to adjust the operating frequency for accessing the first memory package according to a preset temperature threshold.

In an embodiment of the disclosure, a step of determining whether to adjust the operating frequency for accessing the first memory package according to the preset temperature threshold includes: reducing, by the memory storage device, the operating frequency for accessing the first memory package if it is determined that the predicted surface temperature is greater than a first temperature threshold; and increasing, by the memory storage device, the operating frequency for accessing the first memory package if it is determined that the predicted surface temperature is less than a second temperature threshold.

An embodiment of the disclosure provides a memory thermal throttling system, including a testing equipment and a memory storage device. The memory storage device includes a memory control circuit unit and multiple memory packages. The testing equipment performs multiple test modes on the memory storage device, and obtains an internal temperature of the memory control circuit unit, a work loading of each of the memory packages and a surface temperature of each of the memory packages so as to establish a linear relationship between the work loading, the internal temperature, and the surface temperature. The testing equipment stores the linear relationship in the memory storage device. The memory storage device uses the linear relationship based on a current internal temperature of the memory control circuit unit and a current work loading of a first memory package of the multiple memory packages to calculate a predicted surface temperature of the first memory package. The memory storage device adjusts the operating frequency for accessing the first memory package based on the predicted surface temperature.

In an embodiment of the disclosure, when the multiple test modes are performed, the testing equipment transmits at least one command to the memory storage device, and the memory storage device receives and performs the at least one command.

In an embodiment of the disclosure, the at least one command includes at least one of a write command and a read command.

In an embodiment of the disclosure, the memory control circuit unit includes a thermal sensor, and the thermal sensor is configured to measure the internal temperature of the memory control circuit unit.

In an embodiment of the disclosure, the thermal sensor is a thermistor.

In an embodiment of the disclosure, the testing equipment includes a thermal sensor configured to measure the surface temperature of the memory package.

In an embodiment of the disclosure, the work loading includes amount of data written to the memory package.

In an embodiment of the disclosure, an operation of adjusting the operating frequency for accessing the first memory package by the memory storage device based on the predicted surface temperature includes: determining whether to adjust the operating frequency for accessing the first memory package according to a preset temperature threshold.

In an embodiment of the disclosure, an operation of determining whether to adjust the operating frequency for accessing the first memory package according to the preset temperature threshold includes: reducing, by the memory storage device, the operating frequency for accessing the first memory package if it is determined that the predicted surface temperature is greater than a first temperature threshold; and increasing, by the memory storage device, the operating frequency for accessing the first memory package if it is determined that the predicted surface temperature is less than a second temperature threshold.

In summary, according to the memory thermal throttling method and the memory thermal throttling system provided by the embodiments of the disclosure, a relationship between an internal temperature of a memory control circuit unit, a work loading of a memory package, and a surface temperature of a memory package is established. Using the established relationship, the memory storage device predicts a current surface temperature of the memory package according to a current internal temperature of the memory control circuit unit and a work loading of each memory package in operation phase. In this way, the memory storage device can predict the surface temperature of the memory package and adjust an operating frequency for accessing the memory package according to the predicted surface temperature, thereby improving the thermal throttling efficiency.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles of the disclosure.

FIG. 1 is a schematic diagram of a host system, a memory storage device, and an input/output (I/O) device according to an exemplary embodiment.

FIG. 2 is a schematic diagram of a host system, a memory storage device, and an input/output (I/O) device according to another exemplary embodiment.

FIG. 3 is a schematic diagram of a host system and a memory storage device according to another exemplary embodiment.

FIG. 4 is a schematic block diagram of a memory storage device according to an exemplary embodiment of the disclosure.

FIG. 5 is a schematic diagram of a testing equipment of a memory storage device according to an exemplary embodiment of the disclosure.

FIG. 6 is a schematic diagram of testing a memory storage device according to an exemplary embodiment of the disclosure.

FIG. 7 is a flowchart of a memory thermal throttling method according to an exemplary embodiment of the disclosure.

### DESCRIPTION OF THE EMBODIMENTS

Reference will now be made in detail to the exemplary embodiments of the disclosure, examples of which are illustrated in the accompanying drawings. Wherever possible, the same reference numbers are used in the drawings and the description to refer to the same or like parts.

In general, a memory storage device (also known as a memory storage system) includes a rewritable non-volatile memory module and a controller (also known as a control circuit unit). Typically, the memory storage device is used together with a host system, such that the host system may write data to the memory storage device or read data from the memory storage device.

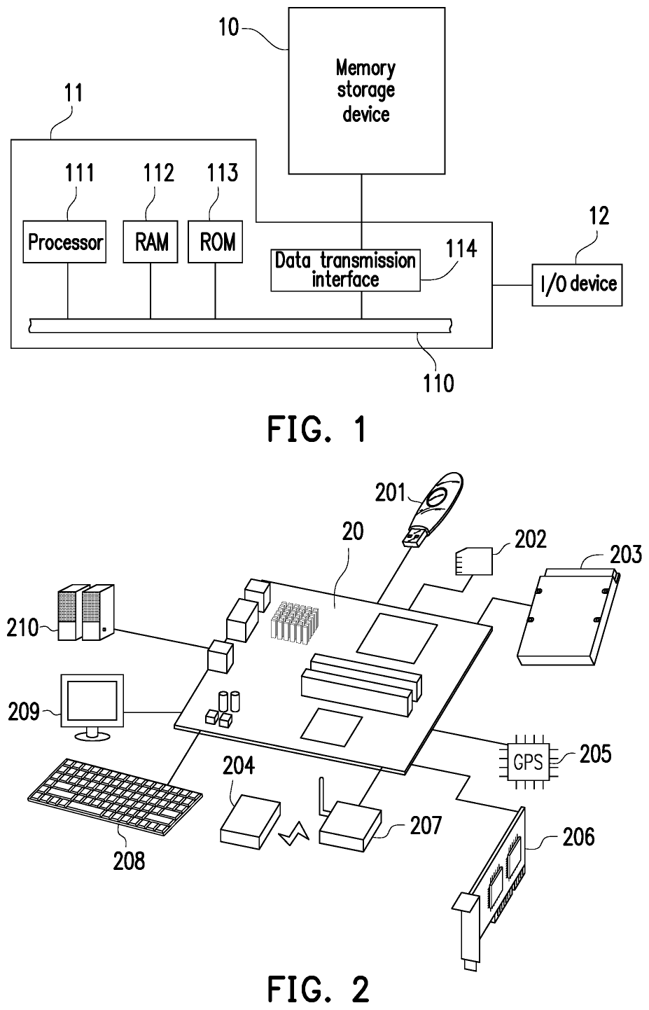

FIG. 1 is a schematic diagram of a host system, a memory storage device, and an input/output (I/O) device according to an exemplary embodiment. And FIG. 2 is a schematic diagram of a host system, a memory storage device, and an input/output (I/O) device according to another exemplary embodiment.

Referring to FIGS. 1 and 2, a host system 11 generally includes a processor 111, a random access memory (RAM) 112, a read-only memory (ROM) 113, and a data transmission interface 114. The processor 111, the random access memory 112, the read-only memory 113, and the data transmission interface 114 are all coupled to a system bus 110.

In this exemplary embodiment, the host system 11 is coupled to a memory storage device 10 by the data transmission interface 114. For example, the host system 11 may write data to the memory storage device 10 or read data from the memory storage device 10 via the data transmission interface 114. Moreover, the host system 11 is coupled to an I/O device 12 by the system bus 110. For example, the host system 11 may transmit output signals to the I/O device 12 or receive input signals from the I/O device 12 via the system bus 110.

In this exemplary embodiment, the processor 111, the random access memory 112, the read-only memory 113, and the data transmission interface 114 may be disposed on a motherboard 20 of the host system 11. The number of the data transmission interfaces 114 may be one or more. Through the data transmission interface 114, the motherboard 20 may be coupled to the memory storage device 10 in a wired or wireless manner. The memory storage device 10 may be, for example, a flash drive 201, a memory card 202, a solid state drive (SSD) 203, or a wireless memory storage device 204. The wireless memory storage device 204 may be a memory storage device based on a variety of wireless communication technologies such as near field communication storage (NFC), Wi-Fi, Bluetooth, or Bluetooth low energy (i.e. iBeacon). Moreover, the motherboard 20 may also be coupled to a variety of I/O devices such as a global positioning system (GPS) module 205, a network interface card 206, a wireless transmission device 207, a keyboard 208, a screen 209, a speaker 210, and the like by the system bus 110. For example, in an exemplary embodiment, the motherboard 20 may access the wireless memory storage device 204 through the wireless transmission device 207.

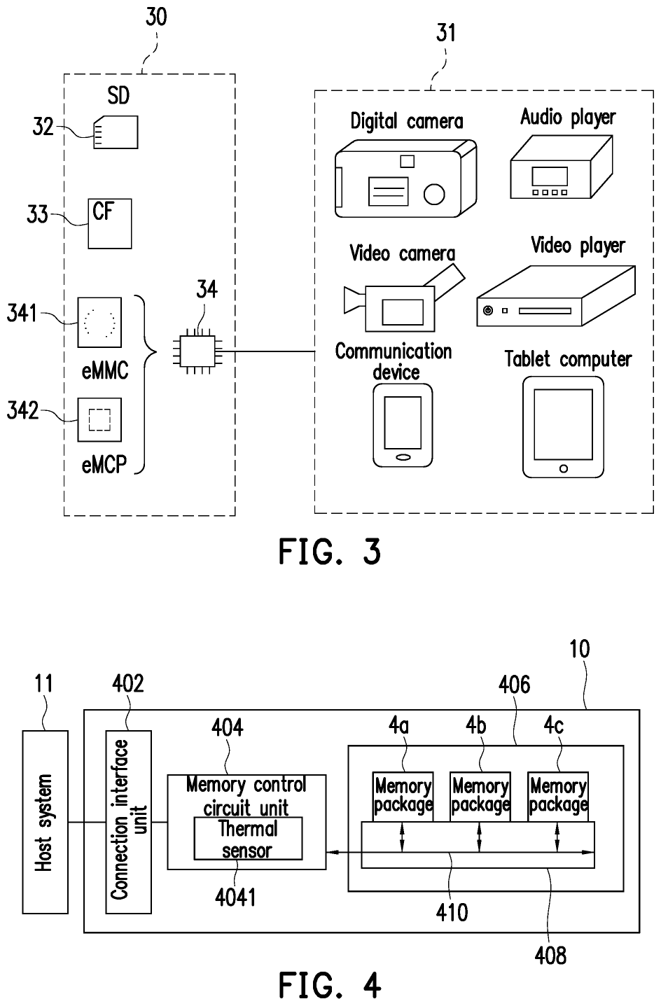

In an exemplary embodiment, the host system may be any system that is capable of working with a memory storage device so as to store data. In the above exemplary embodiment, the host system is described as a computer system, whereas FIG. 3 is a schematic diagram of a host system and a memory storage device according to another exemplary embodiment. Referring to FIG. 3, in another exemplary embodiment, a host system 31 may also be a system such as a digital camera, a video camera, a communication device, an audio player, a video player, or a tablet computer, and a memory storage device 30 may be a variety of non-volatile memory storage devices such as a SD card 32, a CF card 33, or an embedded storage device 34 used. The embedded storage device 34 includes varies types of embedded storage devices such as an embedded Multimedia Card (eMMC) 341 and/or an embedded Multi Chip Package (eMCP) 342 that directly couple a memory module to the substrate of the host system.

FIG. 4 is a schematic block diagram of a memory storage device according to an exemplary embodiment of the disclosure.

4, the memory storage device 10 includes but is not limited to a connection interface unit 402, a memory control circuit unit 404, and a rewritable non-volatile memory module 406.

In this exemplary embodiment, the connection interface unit 402 is compatible with the Serial Advanced Technology Attachment (SATA) standard. However, it must be understood that the disclosure is not limited thereto. The connection interface unit 402 may conform to the Parallel Advanced Technology Attachment (PATA) standard, the Institute of Electrical and Electronic Engineers (IEEE) 1394 standard, Peripheral Component Interconnect Express (PCI Express) standard, Universal Serial Bus (USB) standard, Secure Digital (SD) interface standard, Ultra High Speed-I (UHS-I) interface standard, Ultra High Speed-II (UHS-II) interface standard, Memory Stick (MS) interface standard, Multi-Chip Package interface standard, Multi Media Card (MMC) interface standard, Embedded Multimedia Card (eMMC) interface standard, Universal Flash Storage (UFS) interface standard, embedded Multi Chip Package (eMCP) interface standard, Compact Flash (CF) interface standard, Integrated Device Electronics (IDE) standard or other suitable standards. The connection interface unit 402 and the memory control circuit unit 404 may be packaged in one chip, or the connection interface unit 402 may be arranged outside a chip including the memory control circuit unit 404.

The memory control unit 404 is connected to the host system 11 through the connection interface unit 402, and is connected through a bus 410 to drive and control each of memory packages 4a-4c. The memory control unit 404 is configured to perform multiple logic gates or control commands implemented in hardware or firmware, and perform operations such as writing, reading, and erasing data in each of the memory packages 4a-4c according to the command of the host system 11. In this exemplary embodiment, the memory control unit 404 includes a thermal sensor 4041. The thermal sensor 4041 may include, for example, a thermistor built in the memory control unit 404 so as to measure the temperature of the memory control circuit unit 404 (i.e. an internal temperature T). The thermistor may include a resistor whose resistance value changes with temperature, and the volume change with temperature is more significant than that of general fixed-value resistors.

The rewritable non-volatile memory module 406 includes multiple memory packages 4a-4c mounted on a PCB substrate 408. However, the memory packages 4a-4c in FIG. 4 represent one embodiment of the disclosure, and the disclosure does not limit the number of memory packages included in the memory storage device 10. The memory packages 4a-4c have one or more memory chips built therein, and are configured to store data written according to the host system 11. The memory chip includes an interface chip and a memory cell array, such as a NAND flash memory chip. The memory cell array includes multiple memory cells that may be Single Level Cells (SLC, that is, one memory cell may store one bit), Multi Level Cells (MLC, that is, one memory cell may store two bits), Triple Level Cells (TLC, that is, one memory cell may store three bits), or other types of memory cells.

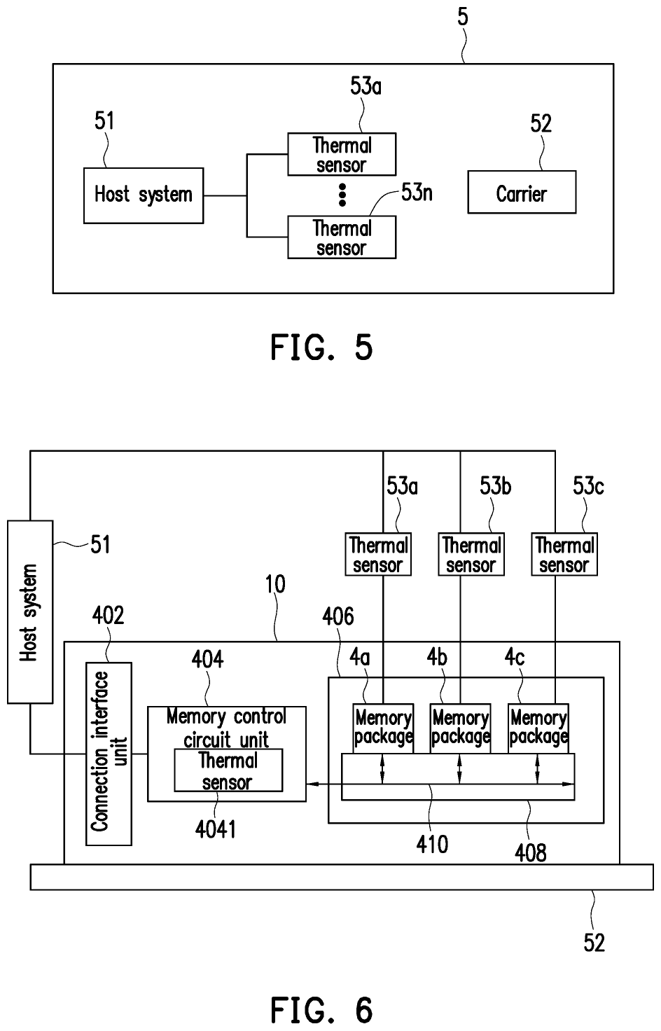

FIG. 5 is a schematic diagram of a testing equipment of a memory storage device according to an exemplary embodiment of the disclosure. Referring to FIG. 5, a testing equipment 5 includes a host system 51, a carrier 52, and a thermal sensor. The thermal sensor may include, for example, multiple thermal sensors 53a-53n shown in FIG. 5. The carrier 52 is configured to carry the memory storage device 10. The thermal sensors 53a-53n are, for example, J-type thermocouple probes, infrared detectors arranged above the memory package, or other sensors that may measure the temperature of the memory package (for example, a surface temperature T_{c}), but the disclosure is not limited thereto.

FIG. 6 is a schematic diagram of testing a memory storage device according to an exemplary embodiment of the disclosure. In the exemplary embodiment of FIG. 6, it is assumed that a J-type thermocouple probe is configured to measure the surface temperature T_{c} of the memory package, and that the memory storage device 10 includes the memory packages 4a-4c. Referring to FIG. 6, the memory storage device 10 may be placed on the carrier 52. The host system 51 is coupled to the connection interface unit 402 to perform data transmission with the memory control circuit unit 404. The thermal sensors 53a-53c may be fixed on surfaces of the memory packages 4a-4c, respectively, and configured to sense the surface temperature T_{c} of the memory packages 4a-4c.

In this exemplary embodiment, the host system 51 stores multiple test modes. The test mode includes at least one command, and the command may include a write command or a read command. In testing phase, the memory storage device 10 to which the firmware is preliminarily written is placed on the carrier 52. The host system 51 transmits at least one command to the memory storage device 10 when performing the test mode. The memory storage device 10 receives and performs the command from the host system 51, and performs the command in a sequential read/write or random read/write manner. While performing the test mode, the host system 51 will receive and record the work loading of each memory package 4a-4c, the surface temperature of each memory package 4a-4c measured by the thermal sensors 53a-53c, and the internal temperature of the memory control circuit unit 404 measured by the thermal sensor 4041. This work loading is recorded by the memory storage device 10 and transmitted to the host system 51. The work loading includes, for example, the amount of data writes, the amount of data reads, the data write speed, and/or the data read speed, and the like of the memory control circuit unit 404 to access the memory package, but the disclosure is not limited thereto. Table 1 below is an example of the test results recorded after the host system 51 performs the test modes.

TABLE 1

| | | Work | Surface | Internal |
|---|---|---|---|---|
| | | loading | temperature | temperature of |
| Test | Memory | of memory | of memory | memory control |
| mode | package | package | package | circuit unit |
| 1 | 4a | WL1 | T_{c1} | Tⱼ₁ |
| | 4b | WL2 | T_{c2} | |
| | 4c | WL3 | T_{c3} | |
| 2 | 4a | WL4 | T_{c4} | Tⱼ₂ |
| | 4b | WL5 | T_{c5} | |
| | 4c | WL6 | T_{c6} | |

Referring to Table 1, assuming that the work loading is related to the amount of data written per unit time; for example, the memory storage device 10 may record the amount of data written to a single memory package with a 4 KB access unit in 10 seconds so as to obtain the amount of data written to the memory package. When the host system 51 performs test mode 1, the work loadings of the memory packages 4a-4c received by the host system 51 are WL1-WL3, the surface temperatures are T_{c1}-T_{c3}, respectively, and the internal temperature of the memory control circuit unit 404 received is Ti. In generally, the surface temperature of the memory package 4a closest to the memory control circuit unit 404 will be affected by the memory control circuit unit 404, so the temperature will be higher. Moreover, in this exemplary embodiment, the data received when the host system 51 performs the test mode 2 may be referred to in Table 1, and will not be repeated here.

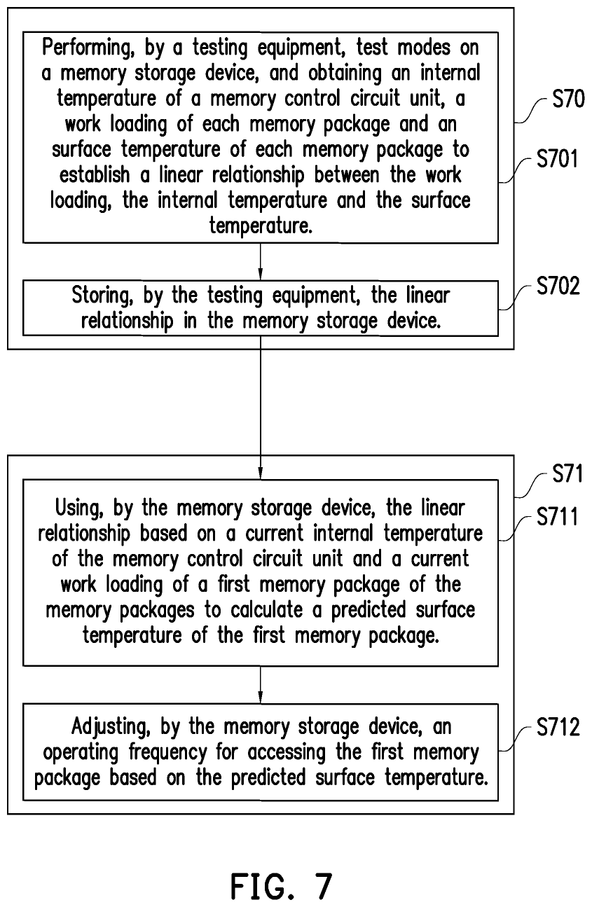

FIG. 7 is a flowchart of a memory thermal throttling method according to an exemplary embodiment of the disclosure. Referring to FIGS. 6 and 7 at the same time, the method of this embodiment is applicable to the testing equipment 5 and the memory storage device 10. The detailed steps of the memory thermal throttling method of the present embodiment will be described with a variety of devices and components of the testing equipment 5 and the memory storage device 10.

Here, testing phase S70 includes steps S701 and S702, and operation phase S71 includes steps S711 and S712.

In step S701, the testing equipment 5 performs multiple test modes on the memory storage device 10, and obtains the internal temperature of the memory control circuit unit 404, the work loading of each memory package and the surface temperature of each memory package so as to establish a linear relationship between the work loading, the internal temperature, and the surface temperature. For example, the host system 51 may use formula (1) to fit the obtained measured data (work loading, internal temperature, and surface temperature) to calculate a coefficient a and a constant b in the formula.

T_{c}[PK]=(a×Tⱼ+b)×WL[PK] (1)

PK represents the number of the memory package, such as 4a-4c in FIG. 6. T_{c}[PK] represents the surface temperature of the memory package PK. a represents a coefficient, and b represents a constant. Tⱼ represents the internal temperature of the memory control circuit unit 404. WL[PK] represents the work loading of the memory package PK.

Taking Table 1 as an example, when the linear relationship of the memory package 4a is to be established, the host system 51 may perform linear fitting based on received work loading WL1 and WL4, the surface temperature T_{c1} and T_{c4}, and the internal temperature Tⱼ₁ and Tⱼ₂ so as to establish the linear relationship between the work loading, the internal temperature, and the surface temperature of the memory package 4a. In this exemplary embodiment, the linear relationship established by the host system 51 is shown in the following formula (2):

T_{c}[4a]=(a×Tⱼ+b)×WL[4a] (2)

T_{c}[4a] represents the surface temperature of the memory package 4a. a represents a coefficient, and b represents a constant. Tⱼ represents the internal temperature of the memory control circuit unit 404. WL[4a] represents the work loading of the memory package 4a. The linear relationships of other memory packages 4b-4c and the linear relationship of the memory package 4a are obtained by fitting in the same manner, and will not be repeated here.

In step S702, the testing equipment 5 stores the linear relationship in the memory storage device 10. After establishing the linear relationship of each memory package, the host system 51 stores the established linear relationship in the memory storage device 10.

In step S711, the memory storage device 10 uses the linear relationship based on the current internal temperature of the memory control circuit unit 404 and the current work loading of the first memory package of the multiple memory packages to calculate a predicted surface temperature of the first memory package. Specifically, the memory storage device 10 may be used together with the host system 11 (which may be different from the host system 51 of the testing equipment 5) as shown in FIGS. 1 and 4 during actual operation. When the memory storage device 10 is operating, the thermal sensor 4041 measures the current internal temperature of the memory control circuit unit 404, and the memory storage device 10 records the current work loadings of the memory packages 4a-4c. The current work loading recorded by the memory storage device 10 is the same as the work loading used when the linear relationship is established.

In this exemplary embodiment, if the memory storage device 10 is to predict the predicted surface temperature of the first memory package (assumed to be the memory package 4a), the memory control circuit unit 404 will use the linear relationship related to the memory package 4a based on the current internal temperature of the memory control circuit unit 404 and the work loading of the memory package 4a to calculate the predicted surface temperature of the memory package 4a. In other words, the memory storage device 10 of this exemplary embodiment does not include the thermal sensor that may measure the memory packages 4a-4c, and therefore the surface temperature of each memory package 4a-4c can be predicted based on the corresponding linear relationship, the current internal temperature, and the current work loading. In this way, the surface temperature of each memory package can be predicted without the need for a thermal sensor for measuring the memory package in the memory storage device 10, thus saving the circuit layout space of the PCB substrate.

In step S713, the memory storage device 10 adjusts the operating frequency (i.e. operating speed) for accessing (i.e. reading and writing) the first memory package based on the predicted surface temperature. Here, the memory storage device 10 reduces the operating frequency for accessing the first memory package when the predicted surface temperature of the first memory package is too high. Further, the memory storage device 10 may also increase the operating frequency for accessing the first memory package when the predicted surface temperature drops to a target temperature. In other words, according to the embodiments of the disclosure, the surface temperature of a single memory package can be predicted, therefore the operating frequency for accessing each memory package can be adjusted according to the surface temperature of each memory package.

In an exemplary embodiment, the memory control circuit unit 404 may determine whether to adjust the operating frequency for accessing the first memory package according to a preset temperature threshold. Specifically, the memory control circuit unit 404 may determine whether the predicted surface temperature is greater than the first temperature threshold (for example, 70° C.). If it is determined that the predicted surface temperature is greater than the first temperature threshold, the memory control circuit unit 404 will reduce the operating frequency for accessing the first memory package. For example, the memory control circuit unit 404 may reduce the first operating frequency for accessing the first memory package to a second operating frequency, and the second operating frequency is lower than the first operating frequency. Further, the memory control circuit unit 404 may determine whether the predicted surface temperature is less than the second temperature threshold (for example, 30° C.). If it is determined that the predicted surface temperature is less than the second temperature threshold, the memory control circuit unit 404 will increase the operating frequency for accessing the first memory package. For example, the memory control circuit unit 404 may restore the second operating frequency for accessing the first memory package to the first operating frequency. It should be noted that the user may set more temperature thresholds and corresponding operating frequencies as the conditions for determining and adjusting the operating frequency according to requirements, and the disclosure is not limited thereto.

In summary, according to the memory thermal throttling method and the memory thermal throttling system provided by the embodiments of the disclosure, a relationship between an internal temperature of a memory control circuit unit, a work loading of a memory package, and a surface temperature of a memory package is established. Using the established relationship, the memory storage device predicts a current surface temperature of the memory package according to a current internal temperature of a memory control circuit unit and a work loading of each memory package in operation phase.

In this way, the memory storage device can predict the surface temperature of a single memory package, and thus can adjust the operating frequency for accessing each memory package according to the surface temperature of each memory package, thereby improving the thermal throttling efficiency.
Further, the surface temperature of each memory package can be predicted without the need for a thermal sensor for measuring the memory package in the memory storage device of the embodiments, thus saving the circuit layout space of the PCB substrate.

It will be apparent to those skilled in the art that various modifications and variations may be made to the structure of the disclosure without departing from the scope or spirit of the disclosure. In view of the foregoing, it is intended that the disclosure cover modifications and variations of this disclosure provided they fall within the scope of the following claims and their equivalents.

What is claimed is:

1. A memory thermal throttling method for a memory storage device, the memory storage device comprising a memory control circuit unit and a plurality of memory packages, the method comprising:
performing, by a testing equipment, a plurality of test modes on the memory storage device, and obtaining an internal temperature of the memory control circuit unit, a work loading of each of the memory packages and a surface temperature of each of the memory packages so as to establish a linear relationship between the work loading, the internal temperature, and the surface temperature;
storing, by the testing equipment, the linear relationship in the memory storage device;
using, by the memory storage device, the linear relationship based on a current internal temperature of the memory control circuit unit and a current work loading of a first memory package of the plurality of memory packages to calculate a predicted surface temperature of the first memory package; and
adjusting, by the memory storage device, an operating frequency for accessing the first memory package based on the predicted surface temperature.

2. The memory thermal throttling method according to claim 1, wherein when the plurality of test modes are performed, the testing equipment transmits at least one command to the memory storage device, and the memory storage device receives and preforms the at least one command.

3. The memory thermal throttling method according to claim 2, wherein the at least one command comprises at least one of a write command and a read command.

4. The memory thermal throttling method according to claim 1, wherein the work loading comprises amount of data written to the memory package.

5. The memory thermal throttling method according to claim 1, wherein a step of adjusting the operating frequency for accessing the first memory package by the memory storage device based on the predicted surface temperature comprises:
determining whether to adjust the operating frequency for accessing the first memory package according to a preset temperature threshold.

6. The memory thermal throttling method according to claim 5, wherein a step of determining whether to adjust the operating frequency for accessing the first memory package according to the preset temperature threshold comprises:
reducing, by the memory storage device, the operating frequency for accessing the first memory package if it is determined that the predicted surface temperature is greater than a first temperature threshold; and
increasing, by the memory storage device, the operating frequency for accessing the first memory package if it is determined that the predicted surface temperature is less than a second temperature threshold.

7. A memory thermal throttling system, comprising:
a testing equipment; and
a memory storage device, comprising a memory control circuit unit and a plurality of memory packages, wherein
the testing equipment performs a plurality of test modes on the memory storage device, and obtains an internal temperature of the memory control circuit unit, a work loading of each of the memory packages and a surface temperature of each of the memory packages so as to establish a linear relationship between the work loading, the internal temperature, and the surface temperature;
the testing equipment stores the linear relationship in the memory storage device;
the memory storage device uses the linear relationship based on a current internal temperature of the memory control circuit unit and a current work loading of a first memory package of the plurality of memory packages to calculate a predicted surface temperature of the first memory package; and
the memory storage device adjusts an operating frequency for accessing the first memory package based on the predicted surface temperature.

8. The memory thermal throttling system according to claim 7, wherein when the plurality of test modes are performed, the testing equipment transmits at least one command to the memory storage device, and the memory storage device receives and performs the at least one command.

9. The memory thermal throttling system according to claim 8, wherein the at least one command comprises at least one of a write command and a read command.

10. The memory thermal throttling system according to claim 7, wherein the memory control circuit unit comprises a thermal sensor, and the thermal sensor is configured to measure the internal temperature of the memory control circuit unit.

11. The memory thermal throttling system according to claim 10, wherein the thermal sensor is a thermistor.

12. The memory thermal throttling system according to claim 7, wherein the testing equipment comprises a thermal sensor configured to measure the surface temperature of the memory package.

13. The memory thermal throttling system according to claim 7, wherein the work loading comprises amount of data written to the memory package.

14. The memory thermal throttling system according to claim 7, wherein an operation of adjusting the operating frequency for accessing the first memory package by the memory storage device based on the predicted surface temperature comprises:
determining whether to adjust the operating frequency for accessing the first memory package according to a preset temperature threshold.

15. The memory thermal throttling system according to claim 14, wherein an operation of determining whether to adjust the operating frequency for accessing the first memory package according to the preset temperature threshold comprises:
reducing, by the memory storage device, the operating frequency for accessing the first memory package if it is determined that the predicted surface temperature is greater than a first temperature threshold; and
increasing, by the memory storage device, the operating frequency for accessing the first memory package if it is determined that the predicted surface temperature is less than a second temperature threshold.
